(19) United States
(12) Patent Application Publication
(10) Pub. No.: US 2007/0026266 A1
(43) Pub. Date: Feb. 1, 2007

(54) Distributed electrochemical cells integrated with microelectronic structures

(76) Inventors: Walter E. Pelton, Fremont, CA (US); Paul J.A. Kenis, Champaign, IL (US)

Correspondence Address: EVAN LAW GROUP LLC, 600 WEST JACKSON BLVD., SUITE 625, CHICAGO, IL, 60661, US

(21) Appl. No.: 11/490,510

(22) Filed: Jul. 19, 2006

Related U.S. Application Data
(60) Provisional application No. 60/700,954, filed on Jul. 19, 2005.

(51) Int. Cl. H01M 8/00

(52) U.S. Cl. 429/7; 429/12; 429/13

(57) ABSTRACT

An electronic device includes an integrated circuit having a plurality of domains, and at least one bias source. Each domain of the plurality of domains is independently electrically connected to at least one of the at least one bias source.

### REFERENCE TO RELATED APPLICATIONS

This application claims the benefit of U.S. Provisional Application Ser. No. 60/700,954 entitled “Methods and apparatuses for distributed fuel cells with transistor system” filed Jul. 19, 2005, which is incorporated by reference in its entirety, except where inconsistent with the present application.

### BACKGROUND

The distribution of power to support large sets of circuit modules has been challenging because the required voltages and acceptable voltage variances both continue to decrease, while the required peak currents continue to increase. For example, a communications processor currently requires a bias source that can provide high current at a low voltage, and a large number of capacitors of multiple values to smooth out high frequency edges and meet surges that fall into different ranges between the high frequency and the response capability of the power supply. Further complications arise from the need to supply a bias source to many separate logic domains, which are isolated from each other. In addition, it is common to have multiple voltage requirements for a single central processor unit. Furthermore, the power is routed by many conductive traces, where even a slight resistance causes large differential voltage drops.

An electrochemical cell is an example of a bias source that may have millimeter or micrometer dimensions. An electrochemical cell includes two half-cells, each of which includes an electrode and a reagent. The reagent in one half-cell undergoes an oxidation reaction at the anode, producing electrons as one reaction product. The reagent in the other half-cell undergoes a reduction reaction at the cathode, consuming electrons as a reactant. Ionic balance between the two half-cells is maintained by an ion-conducting interface between the half-cells. The electron flow from the anode to the cathode will provide an electrical current to an electrical load connected to the two electrodes.

In order for complementary half-cell reactions to take place in an electrochemical cell, ions must travel between the two electrodes. In a conventional electrochemical cell, an ion conducting interface is present between the electrodes. The interface prevents bulk mixing of the reductant and oxidant, but permits ions to flow between the two electrodes. Examples of ion conducting interfaces include a salt bridge, a polymer electrolyte membrane, and an induced dynamic conducting interface (IDCI). Electrochemical cells that include an IDCI are described, for example, in U.S. Pat. No. 6,713,206 B2.

The reagent in the half-cell containing the cathode is an oxidant, since it undergoes a reduction reaction at the cathode. The reagent in the half-cell containing the anode is a reductant, since it undergoes an oxidation reaction at the anode. The electrons produced at the anode can travel through an external circuit to the cathode, where electrons react with the oxidant at the cathode catalyst to produce a reduced product. When the electrochemical cell is a fuel cell, the reductant is a fuel.

Hydrogen, methanol and formic acid have emerged as important fuels for fuel cells, particularly in mobile power and transportation applications. The electrochemical half reactions for a hydrogen fuel cell are listed below.

| | |
|---|---|
| Anode: | 2H₂ → 4H⁺ + 4e⁻ |
| Cathode: | O₂ + 4H⁺ + 4e⁻ → 2H₂O |
| Cell Reaction: | 2H₂ + O₂ → 2H₂O |

To avoid storage and transportation of hydrogen gas, the hydrogen can be produced by reformation of conventional hydrocarbon fuels. In contrast, direct liquid fuel cells (DLFCs) utilize liquid fuel directly, and do not require a preliminary reformation step of the fuel. As an example, the electrochemical half reactions for a Direct Methanol Fuel Cell (DMFC) in acidic conditions are listed below.

| | |
|---|---|
| Anode: | CH₃OH + H₂O → CO₂ + 6H⁺ + 6e⁻ |
| Cathode: | 1.5O₂ + 6H⁺ + 6e⁻ → 3H₂O |
| Cell Reaction: | CH₃OH + 1.5O₂ → CO₂ + 2H₂O |

As another example of a DLFC, the electrochemical half reactions for a Formic Acid Fuel Cell (FAFC) in acidic conditions are listed below.

| | |
|---|---|
| Anode: | HC(═O)OH → CO₂ + 2H⁺ + 2e⁻ |
| Cathode: | O₂ + 2H⁺ + 2e⁻ → 2H₂O |
| Cell Reaction: | HC(═O)OH + O₂ → CO₂ + 2H₂O |

Several types of fuel cells have been constructed, including polymer electrolyte membrane fuel cells, direct methanol fuel cells, alkaline fuel cells, phosphoric acid fuel cells, molten carbonate fuel cells, and solid oxide fuel cells. For a comparison of several fuel cell technologies, see Los Alamos National Laboratory monograph LA-UR-99-3231 entitled Fuel Cells: Green Power by Sharon Thomas and Marcia Zalbowitz.

### SUMMARY

In one aspect, the invention is an electronic device, comprising an integrated circuit comprising a plurality of domains, and at least one bias source. Each domain of the plurality of domains is independently electrically connected to at least one of the at least one bias source.

In a second aspect, the invention is an integrated circuit, comprising a semiconductor substrate, at least one domain on the semiconductor substrate, and at least one fuel cell on the semiconductor substrate. Each domain of the at least one domain is independently electrically connected to a fuel cell of the at least one fuel cell.

In a third aspect, the invention is a gated electrochemical cell, comprising (a) an anode, (b) a cathode, (c) a first conduit contiguous with the anode, (d) a second conduit contiguous with the cathode, and (e) a membrane gate comprising a gate electrode, between the first conduit and the second conduit.

In a fourth aspect, the invention is an electronic device, comprising (A) an integrated circuit, and (B) a plurality of gated electrochemical cells electrically connected to the integrated circuit.

The following definitions are included to provide a clear and consistent understanding of the specification and claims.

The term “electronic device” means a device which includes an electronic circuit. Electronic devices include, for example, microprocessors, application-specific integrated circuits (ASICs), memory chips, analog integrated circuits, computers, mobile phones, airplanes or automobiles.

The term “integrated circuit” means all the semiconductor devices on a single semiconductor substrate, configured to provide an electrical output or outputs in response to an electrical input or inputs.

The term “domain” means an independently electrically connected electronic circuit or portion of an electronic circuit. Domains include, for example, logic domains, arithmetic domains and memory domains.

The term “semiconductor device” means a solid-state circuit element. Semiconductor devices include, for example, resistors, capacitors, p-n diodes, bipolar junction transistors, and field-effect transistors.

The term “bias source” means an element that increases or decreases the electrical potential applied to a system. Examples include fuel cells, batteries, and power supplies.

The term “independently electrically connected” means that an electronic circuit or portion of an electronic circuit may be biased without changing the biasing state of any other electronic circuit or portion of an electronic circuit electrically connected to the same bias source.

The term “membrane gate” means a material having ionic conductivity that can be changed by application of an electric field.

The term “structured membrane” means a membrane gate having one or more ion conductive channels, providing an ion conductive connection across the structure membrane.

The term “porous matrix” means a membrane gate having pores containing an ion conductive substance, providing an ion conductive connection across the structure membrane.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 is a schematic representation of an electronic device.

FIG. 2 is a representation of a gated electrochemical cell.

FIG. 3 is a representation of a gated electrochemical cell having a membrane gate that includes a structured field effect material.

FIG. 4 is a representation of a gated electrochemical cell having a membrane gate that includes a porous field effect material.

FIG. 5 is a perspective representation of a partially constructed gated electrochemical cell.

FIG. 6 is a perspective representation of a partially constructed electrochemical cell system.

FIG. 7A through FIG. 7F are representations of structures formed during an example of a method of making a gated electrochemical cell having a membrane gate that includes a structured field effect material.

FIG. 8A through FIG. 8F are representations of structures formed during an example of a method of making a gated electrochemical cell having a membrane gate that includes a porous field effect material.

FIG. 9 is a representation of a piezoelectric pump.

FIG. 10 through FIG. 13 illustrate structures formed during fabrication of a gated electrochemical cell integrated with a logic module.

FIG. 14 is a representation of a printed circuit board with an integrated gated electrochemical cell/logic module.

FIG. 15 is a schematic representation of a chip including two integrated gated electrochemical cell/logic modules.

FIG. 16 is a schematic representation of a microelectronic system including multiple integrated gated electrochemical cell/logic modules.

### DETAILED DESCRIPTION

The present invention makes use of the discovery that integrated circuit domains in a microelectronic device may be operated with separate bias sources. Moreover, an individual bias source may be integrated with its corresponding integrated circuit domain, providing a dedicated source of bias that is available when required by the domain. Distributing multiple bias sources allows reduction or elimination of the power distribution and regulation system of the device, reducing or eliminating the space and power otherwise used by the power distribution and regulation system. Furthermore, each integrated circuit domain may be supplied with power only when necessary. Preferably, the bias sources are electrochemical cells, more preferably fuel cells. Alternatively, each domain power node may be connected to a pin, allowing each domain of the integrated circuit to be independently electrically connected to a central bias source.

The present invention also makes use of the discovery of a gated electrochemical cell, such as a gated fuel cell, that may be switched on and off by applying a bias to the gate of the cell. Such an electrochemical cell may be a bias source for an integrated circuit domain, and may be integrated with the domain; both the bias source and the domain or domains to which it is electrically connected may be on the same semiconductor substrate. By distributing multiple electrochemical cells as bias sources in a device, each integrated circuit domain may be supplied with power only when necessary, because the electrochemical cells may be switched on and off. The resulting chip, powered by distributed fuel cells, can operate with substantially reduced electrical noise. Since the ground loops are local to each domain, there will only be noise from local logic or signal current.

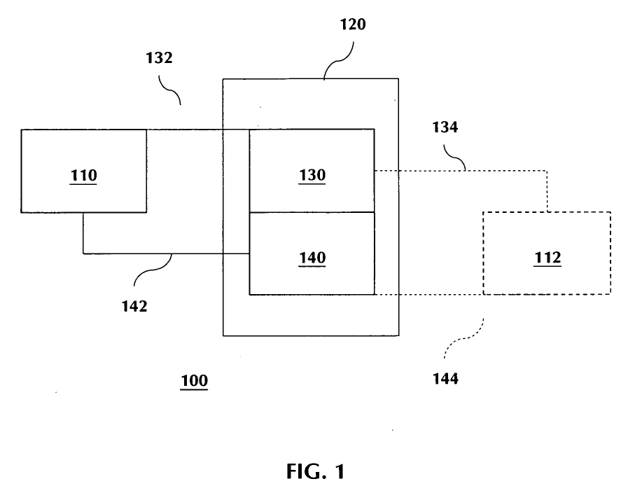

FIG. 1 is a schematic representation of an example of an electronic device 100 including a bias source 110 and an integrated circuit 120, which includes domain 130 and optional domain 140. Electronic device 100 may also include optional bias source 112. If bias source 110 is the only bias source in the device, domains 130 and 140 are independently electrically connected to the bias source through connections 132 and 142, respectively. If the device includes two bias sources, domain 130 may be connected to bias source 110 through connection 132, and domain 140 may be connected to bias source 112 through connection 144. Alternatively, domain 130 may be independently electrically connected to bias source 110 through connection 132 and independently electrically connected to bias source 112 through connection 134, and domain 140 may be independently electrically connected to bias source 110 through connection 142 and independently electrically connected to bias source 112 through connection 144.

The bias source may provide a portion of the bias required by an domain that is independently electrically connected to it, or it may provide all of the bias required. A baseline electric potential may be provided by another bias source. In one example, a baseline electric potential is provided by a primary power supply connected to the device. This baseline electric potential may, for example, preserve the state of the logic, but may not be sufficient for performing logic operations. In this example, the bias source may only need to provide an increase or decrease in the potential applied to a particular domain. Preferably an electronic device includes a dedicated bias source corresponding to each domain in the integrated circuit. Alternatively, multiple bias sources may each be independently electrically connected to a plurality of domains, allowing individual domains to be biased by different bias source at different times. In another alternative arrangement, multiple domains may each be independently electrically connected to a plurality of bias sources

A bias source can be any source of electrical potential. Electrical potential sources include, for example, generators and electrochemical cells. Examples of electrochemical cells include batteries and fuel cells. For an electronic device that includes more than one bias source, the individual bias sources may be of the same type, or they may be of different types. Preferably the bias source is small, lightweight and has a long operation lifetime.

The bias source is preferably an electrochemical cell. Electrochemical cells can operate continuously for an indefinite period of time, provided that fresh reagent is supplied to the cell and that the electrodes are not consumed or contaminated. Microfluidic systems can be used to provide a flow of fresh reagent to the cell.

An electrochemical cell consumes an oxidant and a reductant. For example, MnO₄⁻ can be reduced to Mn²⁺, and Fe²⁺ can be oxidized to Fe³⁺, both in the presence of a platinum catalyst in an acidic environment.

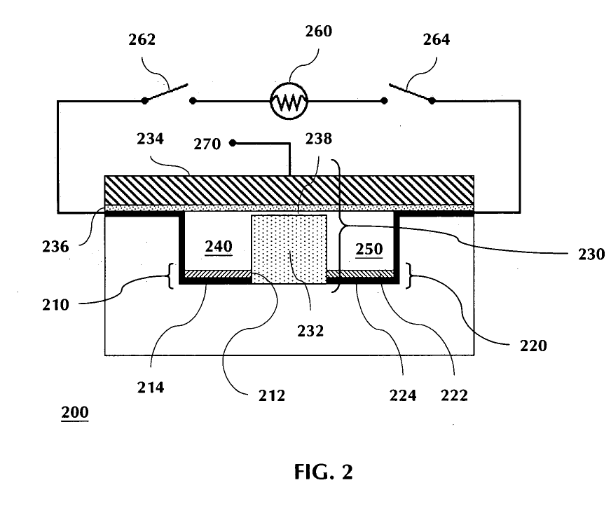

FIG. 2 represents an example of a gated electrochemical cell 200 including an anode 210, a cathode 220, a membrane gate 230 between the anode and the cathode, a first conduit 240 contiguous with the anode and one side of the membrane gate, and a second conduit 250 contiguous with the cathode and the other side of the membrane gate.

The anode 210 includes an anode catalyst 212 and a conductive contact 214. The anode catalyst includes a material that catalyzes the oxidation of a reductant. Examples of anode catalysts include platinum, and combinations of platinum with ruthenium, tin, osmium or nickel.

The conductive contact 214 may be a conductive material, such as a metal, a conducting polymer, or doped polycrystalline silicon. The conductive contact may be connected to an electric load 260 or to an optional switch 262 that can connect the contact to an electric load.

The first conduit 240 allows a fluid, preferably a liquid, to flow in contact with the anode 210 and one side of the membrane gate 230. The fluid may include a reductant that is oxidized at the anode catalyst. Examples of reductants for electrochemical cells include metals, metal salts and metal oxides that can be oxidized to a higher oxidation state. Examples of reductants also include fuels, such as hydrogen or an oxidizable organic compound; in this example, the electrochemical cell would be a fuel cell. Examples of oxidizable organic compounds include organic molecules having one or more carbon atoms but not having adjacent alkyl groups, and where all carbons are either part of a methyl group or are partially oxidized. Examples of such oxidizable organic molecules include methanol, formaldehyde, formic acid, glycerol, ethanol, isopropyl alcohol, ethylene glycol and formic and oxalic esters thereof, oxalic acid, glyoxylic acid and methyl esters thereof, glyoxylic aldehyde, methyl formate, dimethyl oxalate, and mixtures thereof.

The cathode 220 includes a cathode catalyst 222 and a conductive contact 224. The cathode catalyst includes a material that catalyzes the reduction of an oxidant. Examples of cathode catalysts include platinum, and combinations of platinum with cobalt, nickel or iron.

The conductive contact 224 may be a conductive material, such as a metal, a conducting polymer, or doped polycrystalline silicon. The conductive contact may be connected to an electric load 260 or to an optional switch 264 that can connect the contact to an electric load.

The second conduit 250 allows a fluid, preferably a liquid, to flow in contact with the cathode 220 and the other side of the membrane gate 230. The fluid may include an oxidant that is reduced at the cathode catalyst. Examples of oxidants include ozone, hydrogen peroxide, fluorine, chlorine, bromine, and iodine; as well as metals, metal salts and metal oxides that can be reduced to a lower oxidation state, such as permanganate salts and manganese oxide. The first and second conduits 240 and 250 may have the same dimensions, or they may have one or more dimensions that are different.

The fluids in conduits 240 and 250 during operation of the cell may be stationary, or one or both may be flowing. If the fluids are flowing, the flow rates and pressures may be the same or different. The flow in the conduits may be laminar, having minimal or no turbulence, the flow may be turbulent, or the flow may be switched between laminar and turbulent. In one example, the flow is turbulent at least part of the time during operation to regenerate the fluid composition in contact with the electrodes. The fluids in the conduits may independently flow in pulses. In one example, a flow pulse serves to regenerate the reactant concentration in the conduit, which is then depleted by reaction at the electrode. The flow may be pulsed again to bring fresh fluid into the conduit.

In addition to including an oxidant or reductant, the fluids in the conduits 240 and 250 independently may include a carrier gas or liquid. A carrier liquid may contain one or more solvents, and optionally may contain one or more other components, such as a salt, a reaction mediator, an acid, a base, a stabilizer, a buffer, an electrolyte, and a viscosity modifier. The compositions of the carrier gases or liquids in each conduit may be the same or different. Preferably, the carrier liquid contains an electrolyte at a pH of less than 7, for example a pH of 6, 5, 4, 3, 2 or 1.

The membrane gate 230 between a base 232, and a gate electrode 234, and optionally a gate insulator 236 which is between the base 232 and the gate electrode 234 and in contact with the membrane gate 230. The membrane gate 230 may be present in a slot 238 in the base 232. The dimensions of membrane gate, such as a slot containing an electrolyte, may be such that all parts of a cross section of the membrane gate is at most 20 nm to 5 micrometers from the gate electrode. The gate electrode may be connected to an electric potential source 270.

The membrane gate 230 may be a structured membrane, which includes one or more ion conductive channels connecting the conduits 240 and 250, thereby providing an ion conductive connection between the conduits. The channels of a structured membrane may be horizontal slots, or have geometries other than a horizontal slot. In one example, a structured membrane includes one or more vertical slots between the conduits. A vertical slot may extend over part or all of the height of the membrane, and has a length dimension that is a fraction of its width dimension across the membrane. In another example, a structured membrane includes one or more capillaries between the conduits. A capillary has a length dimension and a height dimension that are fractions of the width dimension. Preferably, each channel of the structured membrane has a smallest cross-section area (SCSA) of at most 6.25 square micrometers (μm²), for example from 10 nm² to 6 μm². Preferably, the structured membrane has at least 4 channels, for example 5-100 channels. The channels are ion conductive by virtue of being filled with an ion conductive substance, for example, a liquid electrolyte such as an aqueous solution of a salt, a gel electrolyte such as an aqueous electrolyte containing gelatin, or a solid electrolyte such as NAFION®.

The membrane gate 230 may be a porous matrix, which has pores filled with an ion conductive substance, providing an ion conductive connection between the conduits 240 and 250. Examples of a porous matrix include agar, gelatin, silica gel as well as ceramics and other materials having interconnected pores (see, for example, US Patent Publication No. US 2006/0140843, published on Jun. 29, 2006 “MACROPOROUS STRUCTURES FOR HETEROGENEOUS CATALYST SUPPORT” to Kenis et al.), where the pores are filled with an ion conductive substance. The pores are ion conductive by virtue of being filled with an ion conductive substance, for example, a liquid electrolyte such as an aqueous solution of a salt, a gel electrolyte such as an aqueous electrolyte containing gelatin, or a solid electrolyte such as NAFION®.

The membrane gate 230 may itself be a liquid electrolyte, a gel electrolyte such as an electrolyte containing gelatin, or a solid electrolyte such as NAFION®. In addition, the membrane gate may be a slot 238, filled with an ion conductive substance, providing an ion conductive channel, as represented in FIG. 2; the slot may extend for a portion or for the entire length of the conduits 240 and 250.

The gate electrode 234 is a conducting material, such as a metal, a conducting polymer, or doped polycrystalline silicon. The gate electrode is electrically connected to a switch or bias source that can apply an electric potential to the electrode. The gate electrode is electrically insulated from the reactants and is biased with respect to them. The gate electrode may have any configuration so that an electric field can be applied to a cross section of the membrane gate, having sufficient strength to change the ionic conductivity of the membrane gate. For example, the gate electrode may be over the membrane gate, under the membrane gate, surrounding the membrane gate, or even be a wire which passes through the membrane gate. When the gate electrode is a wire which passes through the membrane gate, it may be horizontal, vertical, curved, or spiraled, for example. Preferably, a gate insulator separates the gate electrode from the membrane gate.

The optional gate insulator 236 may include a dielectric material. Examples of dielectrics include plastics, silicon dioxide, silicon oxynitride, silicon nitride, as well as high-K dielectric materials. The gate insulator 236 may be in contact with the membrane gate 230. Preferably, when the membrane gate is an aqueous solution silicon dioxide is in contact with the solution, and preferably the gate insulator is silicon dioxide or a glass.

During the operation of gated electrochemical cell 200, a fluid including a reductant is present in the first conduit, and a fluid including an oxidant is present in the second conduit. The half-cell reaction of the reductant at the anode catalyst 212 produces electrons and an oxidized product. The electrons produced at the anode can travel through an external circuit to the cathode, where electrons react with the oxidant at the cathode catalyst 222 to produce a reduced product.

The gated electrochemical cell 200 may be turned on and off by switching the membrane gate 230 between conducting and non-conducting states. This switching may be accomplished by changing the electric potential at the gate electrode 234. At a first electric potential, the membrane gate either does not conduct ions or conducts ions at a level that is too low to allow significant reaction at the electrodes (non-conducting state). At a second electric potential, the membrane gate conducts ions at a level sufficient to allow significant reaction at the electrodes (conducting state).

One possible explanation for this change in ionic conductivity of the membrane gate 230 is that the concentration of ionic carriers is modified by the level and/or polarity of the electric field applied by the gate electrode 234. This is similar to the formation of an inversion layer near the surface of a semiconductor substrate in a field effect transistor (FET). If the membrane gate 230 has sufficiently high ion conductivity, it can conduct ions between the first and second conduits 240 and 250, completing the electrochemical cell.

For example, when an electric potential is applied to the gate electrode 234, the electronic properties of the membrane gate 230 may change in response to the applied electric field. Ions concentrated in, for example, liquid present in slot 238, provide an increased concentration of charge carriers between the two conduits and allowing ions to flow between the conduits. The ionic conductivity of the ion conductive substance in the slot 238 may then change, either increasing or decreasing its conductivity for anions and/or cations. As the height and/or length dimensions of the slot extending between the conduits decreases, a liquid present in the slot may become more viscous or solid-like; however, the liquid still conducts ions.

In another example, when an electric potential is applied to the gate electrode 234, ions concentrate in a porous matrix, specifically into the ion conductive substance in the pores of the porous matrix, providing an increased concentration of charge carriers in the liquid between the two conduits and allowing ions to flow between the conduits.

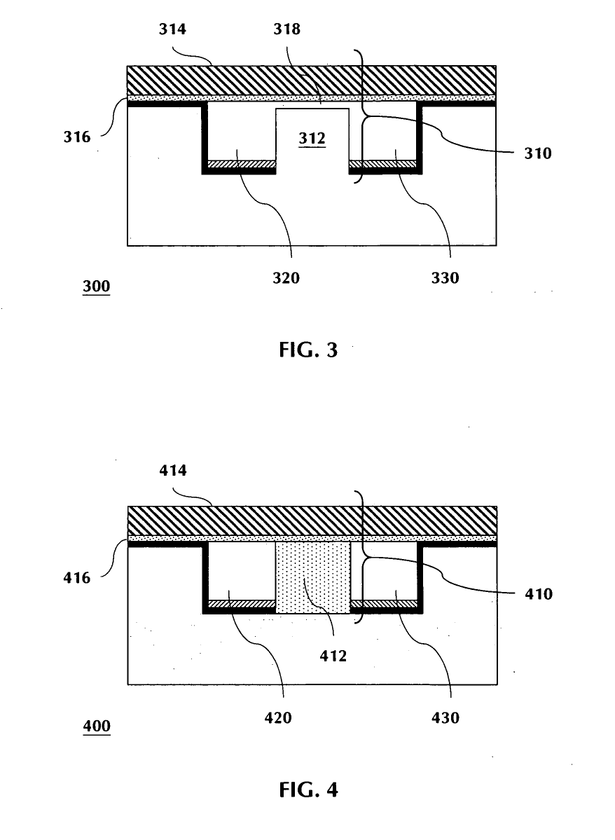

FIG. 3 represents an example of a gated electrochemical cell 300 having a membrane gate 310 on a substrate 312, and including a gate electrode 314, and a gate insulator 316. The substrate 312 is separated by slot 318 from the gate insulator 316. The slot 318 connects a liquid in a first conduit 320 with a liquid in a second conduit 330. The substrate 312 may be polycrystalline or single crystal silicon doped with P- or N-type dopants.

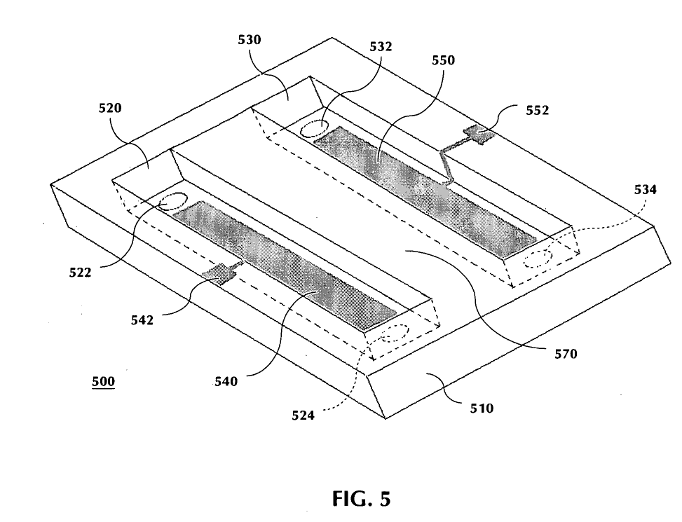

FIG. 4 represents an example of a gated electrochemical cell 400 having a membrane gate 410 including a porous matrix 412, a gate electrode 414, and a gate insulator 416. The porous matrix 412 may be a highly porous material, such a porous silicon or silica gel, filled with an electrolyte. The membrane gate 410 may completely separate a first conduit 420 from a second conduit 430. Alternatively, there may be one or more slots or capillaries providing a structured membrane in place of the porous matrix 412. In another alternative arrangement, a solid electrolyte such as NAFION® may be present in place of the porous matrix 412.

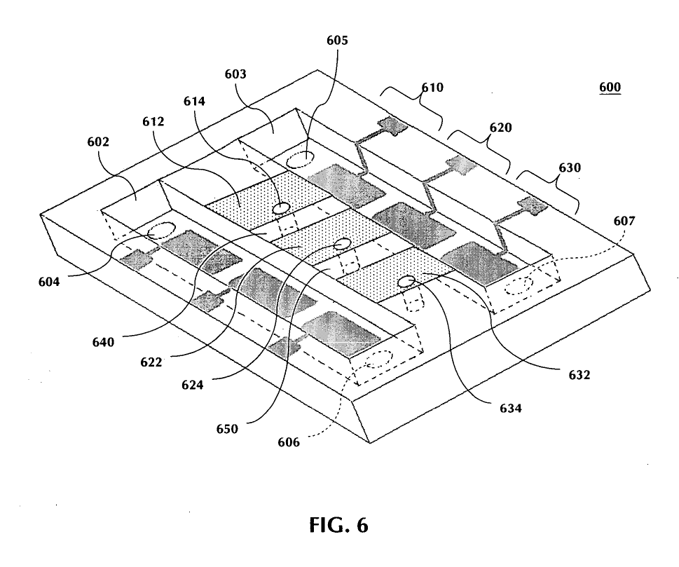

FIG. 5 represents a perspective view of a partially constructed gated electrochemical cell. Structure 500 includes a substrate 510, two conduits 520 and 530, an anode 540, a cathode 550, and a membrane gate 570. Conduit 520 includes an inlet 522 and an outlet 524, and conduit 530 includes an inlet 532 and an outlet 534. Anode 540 and cathode 550 are electrically connected to contacts 542 and 552, respectively. The anode and cathode may be located on the bottoms and/or on the sides of the conduits. The anode and cathode may intersect the inlets and/or the outlets, or the layers may be configured not to contact the inlets and outlets. Membrane gate 570 may include a structured membrane or a porous matrix. Structure 500 may be combined with a cap layer to form a gated electrochemical cell.

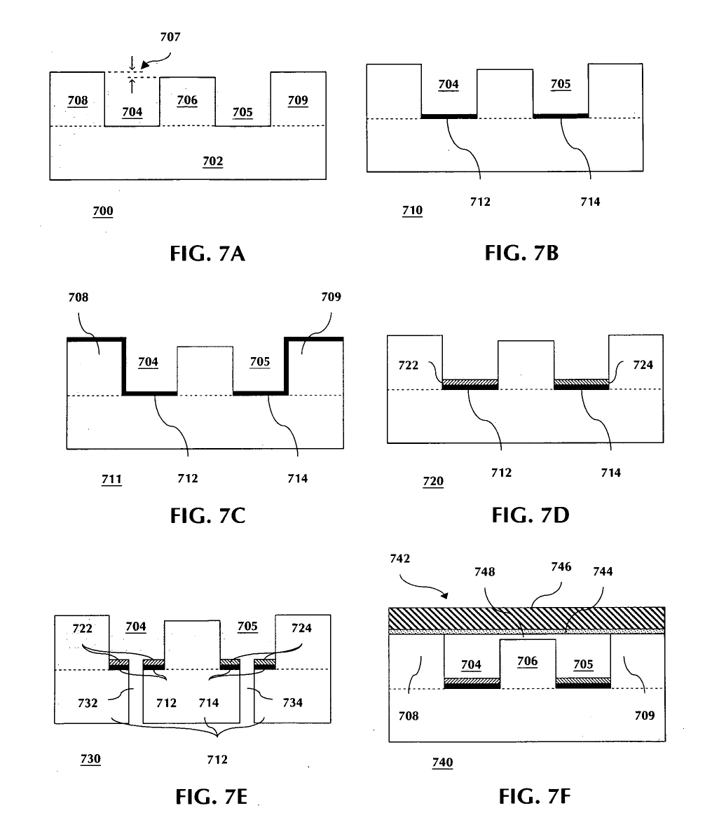

Individual gated electrochemical cells may be configured to share a common set of conduits. FIG. 6 represents a perspective view of a partially constructed electrochemical cell system 600 including individual electrochemical cells 610, 620 and 630, each of which are connected to conduits 602 and 603. Electrochemical cell 610 includes membrane gate 612, electrochemical cell 620 includes membrane gate 622, and electrochemical cell 630 includes membrane gate 632. The conduits 602 and 603 contain inlets 604 and 605, and outlets 606 and 607, respectively.

The individual electrochemical cells 610, 620 and 630 may be separated by isolation regions 640 and 650, such that the on or off status of one of the electrochemical cells does not affect the status of the other electrochemical cells. The isolation regions may be formed as part of the patterned etching of the substrate and/or the conduits, or the isolation regions may be formed separately. Each electrochemical cell may also include a via 614, 624 or 634 through the membrane gate near the isolation regions or near the outlets. These vias can drain liquid from the membrane gate, which may help to remove reaction products and replenish the liquid between the conduits.

Gated electrochemical cells may be formed using standard semiconductor processing techniques. Examples of processes in semiconductor manufacturing include lithography, etching, polishing, chemical vapor deposition (CVD), and physical vapor deposition (PVD). Semiconductor processes for use in the present invention are well known to those of ordinary skill in the art, and are also described in Encyclopedia of Chemical Technology, Kirk-Othmer, Volume 14, pp. 677-709 (1995); Semiconductor Device Fundamentals, Robert F. Pierret, Addison-Wesley, 1996; Wolf, Silicon Processing for the VLSI Era, Lattice Press, 1986, 1990, 1995 (vols 1-3, respectively); Microchip Fabrication 4th. edition, Peter Van Zant, McGraw-Hill, 2000.

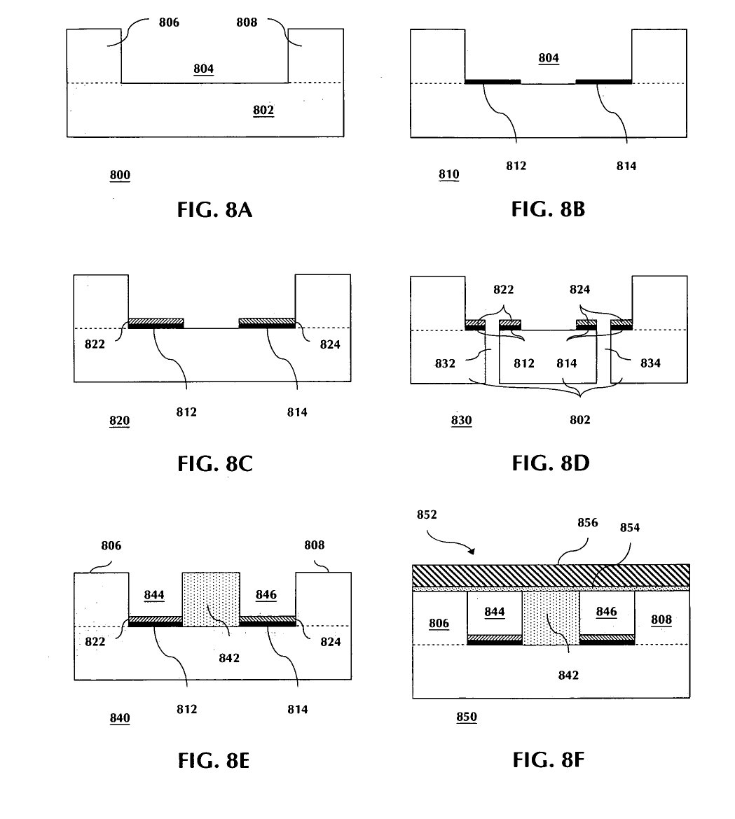

FIGS. 7A to 7F represent structures formed during an example of a method of making a gated electrochemical cell. In FIG. 7A, structure 700 includes a substrate 702, two conduits 704 and 705, an intermediate region 706 between the two conduits, and walls 708 and 709. The intermediate region 706 may have a difference in height 707 relative to the height of the walls 708 and 709.

The substrate 702, intermediate region 706, and walls 708 and 709 may be integral, they may be the same material, or they independently may be different materials. In one example, the intermediate region and walls are insulators, and the substrate is a semiconductor. In another example, the substrate and intermediate region are semiconductors, and the walls are insulators. In another example, the substrate, walls and intermediate region are integral and semiconductors. In another example, the substrate, walls and intermediate region are integral and are formed from a single crystal semiconductor substrate. Semiconductor materials may be doped or undoped, and the doping may be uniform, or it may vary depending on the location within the material. Preferably the substrate 702 is a semiconductor. The intermediate region will become part of the membrane gate, or may become the base under the membrane gate.

The structure 700 may be formed from a single semiconductor substrate, for example by micromachining or by photolithographic techniques. In an example of a photolithographic method, the intermediate region and conduits together are three minimum line-widths wide (minimum line-width is also referred to as critical dimension or CD). The depth of the intermediate region, corresponding to height difference 707, may be from 0.01 to 0.2 times the depth of the conduits.

In FIG. 7B, structure 710 includes conductive layers 712 and 714 in each conduit 704 and 705. The conductive layers may also be on at least a portion of the walls to facilitate a connection between the conductive layer and an external switch or load. This is illustrated in FIG. 7C, where structure 711 includes conductive layers 712 and 714 on walls 708 and 709. In FIG. 7D, structure 720 includes an anode catalyst 722 and a cathode catalyst 724 on the conductive layers 712 and 714, respectively.

To form inlets and outlets for a conduit, vias may be formed at each end of the conduit. In FIG. 7E, structure 730 includes vias 732 and 734 in conduits 704 and 705. The vias may be formed at any point in the fabrication process. The vias may intersect the electrode layers (712, 714) and/or the catalyst layers (722, 724) as shown, or they may only contact the substrate 702.

In FIG. 7F, structure 740 includes a cap layer 742 that is bonded to the walls 708 and 709 and that extends over the conduits 704 and 705 and the intermediate region 706. The cap layer 742 may optionally include an insulating layer 744, and includes a conducting layer 746, and may be separated from the intermediate region by slot 748. Structure 740 can be a gated electrochemical cell having a membrane gate.

In one example, the cap layer 742 may be formed by first depositing a tenting resist film over structure 720 and/or 730, such that the film contacts the walls 708 and 709 but does not contact the intermediate region 706. The resist film can be etched in a pattern to expose features such as electrical contact areas or dicing lines. An insulating layer may be formed on the resist film, or the resist film can be the insulating layer. A conducting layer can then be deposited to complete the cap layer. In another example, the cap layer may be formed in a separate process and then contacted with the walls 708 and 709. A sealant such as a glop-top layer may be applied to some or all of structure 740, to ensure that the electrochemical cell can sustain the fluid pressures experienced during operation. Alternatively, conduits 704 and 705 may be filled with a sacrificial material, such as resist, and the insulating layer 744 and conductive layer 746 formed on top; the sacrificial material may then be removed by dissolving or etching it away.

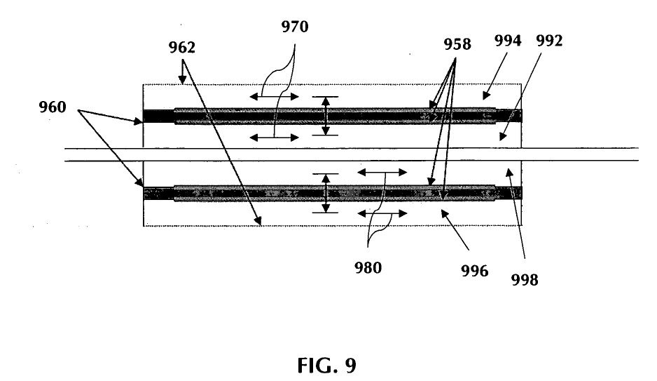

FIGS. 8A to 8F represent structures formed during another example of a method of making a gated electrochemical cell. In FIG. 8A, structure 800 includes a substrate 802 and a trench 804 having walls 806 and 808. The substrate 802 and walls 806 and 808 may be integral, they may be the same material, or they independently may be different materials. In one example, the substrate and walls are insulators. In another example, the substrate is a semiconductor, and the walls are insulators. In another example, the substrate and walls are integral and are formed from a single crystal semiconductor substrate, for example, by micromachining or by photolithography. Semiconductor materials may be doped or undoped, and the doping may be uniform, or it may vary depending on the location within the material.

In FIG. 8B, structure 810 includes conductive layers 812 and 814 on two separate portions of the trench 804. In FIG. 8C, structure 820 includes an anode catalyst 822 and a cathode catalyst 824 on the conductive layers. In FIG. 8D, structure 830 includes vias 832 and 834 in the semiconductor substrate 802. These vias may provide inlets and outlets for the conduits, and may be formed at any point in the fabrication process. The vias may intersect the electrode layers (812, 814) and/or the catalyst layers (822, 824) as shown, or they may only contact the substrate 802.

In FIG. 8E, structure 840 includes a porous matrix 842 between the anode catalyst 822 and conductive layer 812, and the cathode catalyst 824 and conductive layer 814. Conduits 844 and 846 are thus formed between the porous matrix 842 and the walls 806 and 808. In FIG. 8F, structure 850 includes a cap layer 852 that is bonded to the walls 806 and 808 and that extends over the conduits 844 and 846. The cap layer 852 may contact the porous matrix 842. The cap layer 852 includes an optional insulating layer 854, and includes a conducting layer 856. Structure 850 can be a gated electrochemical cell having a membrane gate that includes a porous matrix.

In one example, the cap layer 852 may be formed by first depositing a tenting resist film over structure 840, such that the film contacts the porous matrix 842 and walls 806 and 808. The resist film can be etched in a pattern to expose features such as electrical contact areas or dicing lines. An insulating layer 854 may be formed on the resist film, or the resist film can be the insulating layer 854. A conducting layer can then be deposited to complete the cap layer. In another example, the cap layer may be formed in a separate process and then contacted with the porous matrix 842 and walls 806 and 808. A sealant such as a glop-top layer may be applied to some or all of structure 850, to ensure that the electrochemical cell can sustain the fluid pressures experienced during operation.

A gated electrochemical cell may be supplied with reactants by a microfluidic system. A microfluidic system may include reservoirs for the liquids containing the reductant and oxidant, microfluidic channels for the liquids, and a pump to induce liquid flow in the channels. A microfluidic system may include additional components, such as one or more flow control devices, a recycling system, and temperature controls.

A microfluidic system may include a microfluidic channel that directs fluid from a reservoir to an inlet in a conduit in a gated electrochemical cell. The microfluidic system may also include a microfluidic channel that directs fluid from an outlet in a gated electrochemical cell conduit to a waste receptacle or to a recycling system.

The microfluidic system may be formed in a substrate that is then attached to the back side of the substrate of a gated electrochemical cell. Registration of the two substrates to each other can provide for alignment of the inlet and outlet vias with the corresponding microfluidic channel for the reductant inlet, reductant outlet, oxidant inlet and oxidant outlet. Preferably the microfluidic system is formed in the substrate of the gated electrochemical cell. For example, the microfluidic channels may be formed on one side of a substrate, and the trench or conduits for the electrochemical cell may be formed on the other side of the same substrate, or on the same side.

Access to the conduits of the electrochemical cell can be achieved by etching vias through the substrate and/or by forming openings through the cap layer. In one example, the inlets to the two conduits pass through the cap layer, and the outlets from the two conduits pass through the substrate. In this example, the microfluidic supply channels are above the electrochemical cell, and the microfluidic return channels are below the electrochemical cell. In another example, the inlet and outlet for one of the conduits pass through the cap layer, and the inlet and outlet for the other conduit pass through the substrate. In this example, the microfluidic channels for each reactant are on opposite sides of the electrochemical cell. In another example, all of the microfluidic channels are on one side of the electrochemical cell and have access to the appropriate conduits through vias in the substrate.

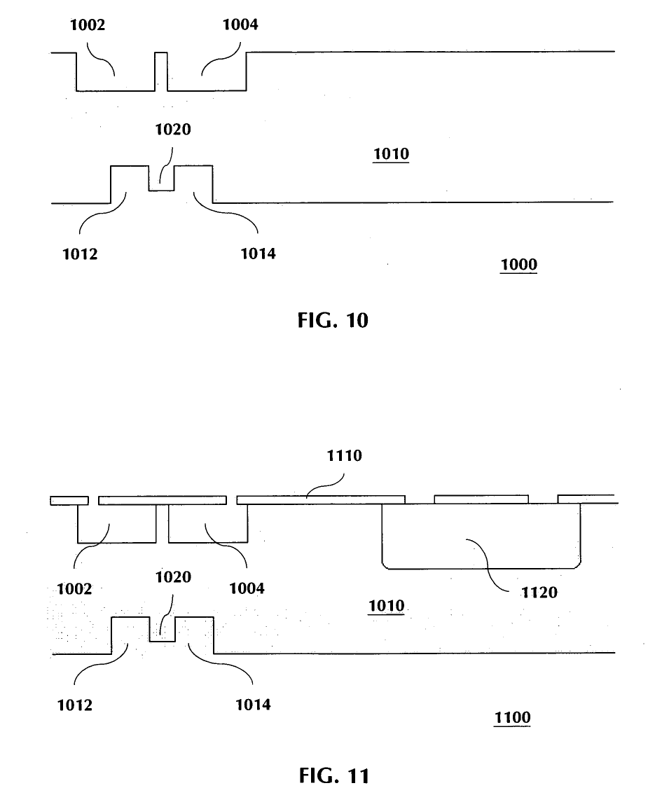

Examples of pumps include mechanical pumps and piezoelectric pumps. Mechanical pumps include, for example, syringe pumps and pistons. FIG. 9 represents an example of a piezoelectric pump for a microfluidic system. As illustrated, the piezoelectric pump includes electrodes 958, rigid membranes 962, and piezoelectric actuators 960. During operation, the piezoelectric pump moves fluid containing a reductant 970 (such as fuel) through channels 992 and 994, and fluid containing an oxidant 980 through channels 996 and 998.

A flow control device may be present in a microfluidic system to control the amount and/or direction of fluid flow. Flow control devices may be especially useful in a microfluidic system that processes fluid for more than one set of conduits. Examples of flow control devices include solenoid valves, and piezoelectric valves.

A recycling system may be present in a microfluidic system to isolate reaction products or contaminants from the reactant fluids. Each fluid from the conduit outlets may have a dedicated recycling system, or the two fluids may share a common recycling system. An electrochemical cell may be operated such that one or both of the reactants is completely consumed during the cell reaction, such that the exiting fluid includes only carrier gas or liquid that can be directed back to a fluid reservoir. In addition, fluid that may drain directly from the slot of an electrochemical cell having a structured field effect material may be recycled, vented, or directed to a waste receptacle. If the slot liquid is recycled, it may have a dedicated recycling system, or it may share a recycling system with one or both of the conduit fluids.

Temperature controls may be present in a microfluidic system to dissipate heat that may build up in the fluids. The temperature of a fluid in a gated electrochemical cell may increase due to an exothermic reaction between the reactants. The temperature of a fluid in a gated electrochemical cell may increase due to the electric work performed by a load connected to the cell.

In one example, the fluid temperature may be controlled by a heat exchanger. For example, microfluidic channels may pass through a thermally conductive material, which may be configured with plates that allow heat to be radiated to the surrounding environment.

A gated electrochemical cell may be connected to a semiconductor structure or a semiconductor device. When the structure or device is accessed in a processing operation, the power required to operate the structure or device may be provided at least in part by the electrochemical cell.

One or more semiconductor structures may be formed on the same semiconductor substrate as a gated electrochemical cell. One or more semiconductor structures may be formed in a stacking arrangement with a gated electrochemical cell. For example, a gated electrochemical cell may have a cap layer that is sufficiently flat to allow for further semiconductor processing. The top portion of the cap layer thus becomes the substrate for forming one or more semiconductor structures.

The following examples are provided to illustrate one or more preferred embodiments of the invention. Numerous variations may be made to the following examples that lie within the scope of the invention.

### EXAMPLES

### Example 1

### Fabrication Of A Gated Electrochemical Cell Integrated With A Logic Module

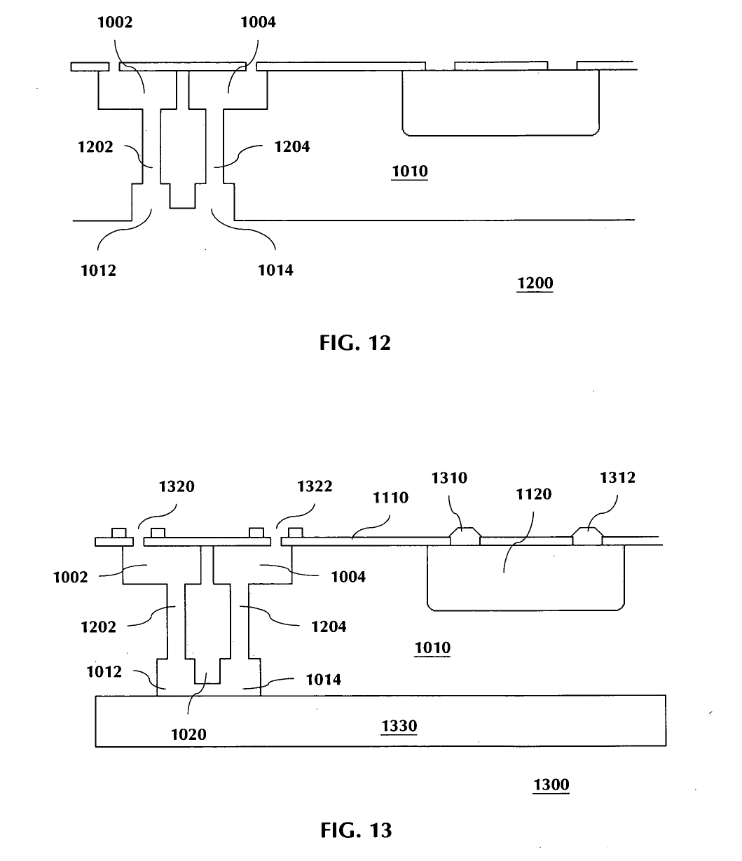

A silicon wafer is etched on both sides with different patterns. On one side, the pattern corresponds to microfluidic channels for a microfluidic network. Separate microfluidic channels are formed for reductant inlet, reductant outlet, oxidant inlet, oxidant outlet, and mixed liquid drain. On the other side, the pattern corresponds to pairs of conduits for one or more electrochemical cells, and an intermediate region between the conduits. The depth and with dimensions of the conduits independently are from 10 to 200 micrometers. The intermediate region has a width on the order of the conduit widths, and a depth of from 1 to 5 micrometers. The etching may be performed using semiconductor fabrication techniques or micromachining. FIG. 10 is a representation of a structure 1000 that includes wafer 1010 in which microfluidic channels 1002 and 1004, conduits 1012 and 1014, and an intermediate region 1020 have been formed.

A logic module containing one or more transistors is formed on the side of the wafer containing the microfluidic network. A tenting resist film is applied over the microfluidic network and logic. The tenting resist is patterned to provide fluid access to the microfluidic network and to provide electrical access to the logic. The logic module and patterned tenting resist film are formed using conventional semiconductor processing techniques. FIG. 11 is a representation of a structure 1100 that may be formed from structure 1000. Structure 1100 includes wafer 1010, microfluidic channels 1002 and 1004, conduits 1012 and 1014 separated by intermediate region 1020, patterned tenting resist film 1100, and logic module 1120.

A photoresist layer is applied to the conduit side of the wafer. The layer is patterned, and then vias are etched from the conduits to the microfluidic channels. These vias can provide fluid inlets and outlets to the conduits. FIG. 12 is a representation of a structure 1200 that may be formed from structure 1100. Structure 1200 includes vias 1202 and 1204 through wafer 1010, connecting microfluidic channels 1002 and 1004 with conduits 1012 and 1014, respectively.

The conduit side of the wafer is again covered with a patterned photoresist. A layer of nickel is formed on the base of each conduit between the inlet and outlet vias, and extends out of the conduits to form interconnect areas. The layer of nickel may be formed by evaporation or sputtering. Another patterned photoresist is formed, and gold is deposited by electrolysis onto portions of the nickel layer, forming the electrode areas in the base of each conduit. Alternatively, the gold may be deposited directly, without an intervening layer of nickel, by evaporation or sputtering. A platinizing solution containing 3 grams of chloroplatinic acid and 0.02 grams of lead acetate in 100 grams of distilled water is then contacted with each electrode, and a layer of black platinum is formed. The photoresists are removed to provide the anode and cathode in the conduits.

The assembly of the electrochemical cell is completed by bonding the side of the wafer having the conduits to a sapphire substrate. The conduits are sealed, with the only inlets and outlets located at the vias. Solder bumps are formed on the resist openings above the logic module by flip-chip application. The resist openings above the microfluidic channels are surrounded with low temperature port connect rings by jet printing a thermosetting paste. The rings solidify to become connecting tubes to mounting inlet and outlet tubes. FIG. 13 is a representation of a structure 1300 that may be formed from structure 1200. Structure 1300 includes wafer 1010 having microfluidic channels 1002 and 1004, conduits 1012 and 1014, vias 1202 and 1204, and intermediate region 1020; patterned tenting resist film 1100; logic module 1120; solder bump connects 1310 and 1312; fluid connects 1320 and 1322; and cap layer 1330.

### Example 2

### Combination Of A Printed Circuit Board With An Integrated Gated Electrochemical Cell/Logic Module

Gated electrochemical cells, such as the cell formed in Example 1, are connected to a microfluidic network and used to provide power to their integrated logic modules. The process of Example 1 may be used to form multiple integrated electrochemical cells and associated logic modules, and a single substrate containing one or more of these integrated electrochemical cell/logic modules is referred to as a “chip.” One or more chips may be mounted to a circuit board.

Once the conventional layers of metal on a printed circuit board have been processed, such as by etching and through-hole plating, a patterned protective layer is applied in the form of a conformal coating or a film-type photosensitive elastomer and then cured to a hard refractory surface. To produce channels for the reactant liquids, a second layer is applied and then selectively removed. The pattern of this layer includes the fluid channels as well as openings for electrical contacts. A top layer is then formed over this layer by deposition of a tenting resist film to seal the fluid channels. The top layer is patterned to provide openings for the electrical contacts. Fluid contacts are formed through the circuit board to the microfluidic network. Chips may be connected to the printed circuit board by aligning the fluid connects and solder bumps of the chips with the electrical contacts and fluid contacts of the board.

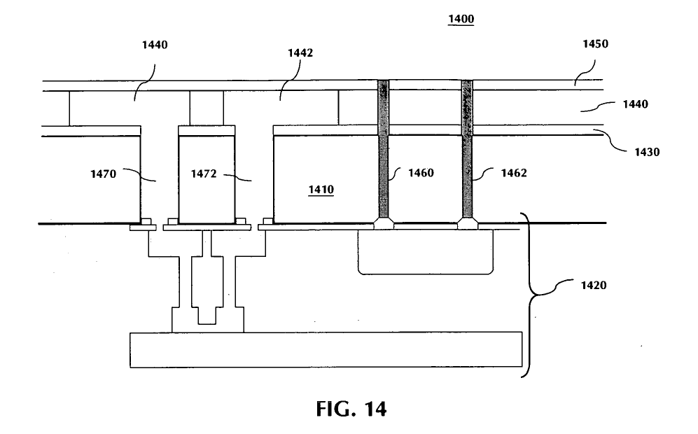

FIG. 14 is a representation of a structure 1400 including a printed circuit board 1410 connected to a chip 1420, a patterned protective layer 1430, a fluid channel layer 1440, and a top layer 1450. Electrical contacts 1460 and 1462 extend through the layers and the printed circuit board 1410 to connect to the logic module of the chip 1420. Fluid contacts 1470 and 1472 provide two of the fluid connections between fluid channels 1442 and 1444 with the microfluidic network of the chip 1420.

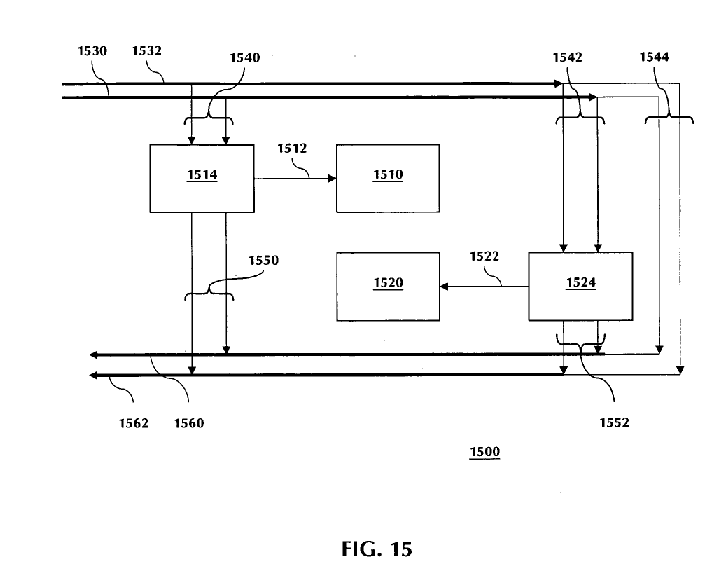

FIG. 15 is a schematic representation of a chip 1500 including two logic modules 1510 and 1520 independently powered through electrical connections 1512 and 1522 by integrated electrochemical cells 1514 and 1524, respectively. The reductant and oxidant are directed to the microfluidic network of the chip under a regulated absolute pressure through fluid contacts 1530 and 1532, respectively. Microfluidic channels on the chip split to form three pairs of streams, each pair including a reductant stream and an oxidant stream. Inlet pairs 1540 and 1542 are each directed to a separate electrochemical cell. Pair 1544 is directed through a pattern under the chip to collect heat and to establish the desired pressure drop. Outlet pairs 1550 and 1552 from the electrochemical cells are combined with pair 1544, and the used reductant and oxidant liquids are removed from the chip through fluid contacts 1560 and 1562.

### Example 3

### Self-Contained Gated Electrochemical Cell/Logic Module System

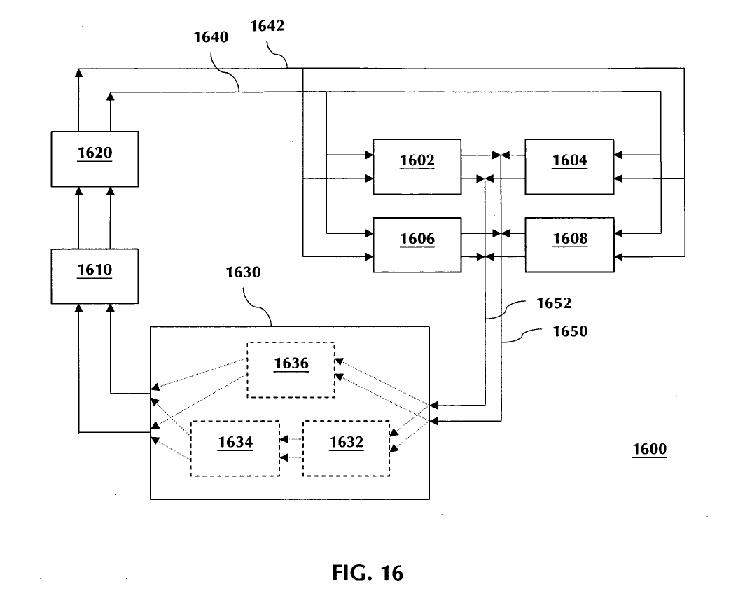

A circuit board containing one or more chips, such as the circuit board formed in Example 2, is connected to a microfluidic system to provide a fully functional, self-contained microelectronic system. FIG. 16 is a schematic representation of a microelectronic system 1600 including multiple chips 1602, 1604, 1606 and 1608; reservoir 1610; pump 1620; recycler 1630; fluid channels 1640 and 1642; and microfluidic outlet channels 1650 and 1652.

A reductant liquid stream and an oxidant liquid stream are produced from reservoir 1610 by pump 1620. The reservoir and pump each include separate components for processing the reductant liquid and the oxidant liquid. The pump is powered by an external power supply, such as a battery, an alternating current source, or a separate electrochemical cell. Once one or more of the chips (1602, 1604, 1606, 1608) is switched on to produce an electric current, the pump is powered at least in part by the electrochemical cells of the chips. The reductant liquid and the oxidant liquid are directed to the chips through fluid channels 1640 and 1642, respectively. The pressure of each liquid is regulated to be a standard operation pressure that stabilizes the delivery rates of the reactants to the chips. Each of the inlet channels 1640 and 1642 are split into separate microfluidic inlet pairs for each chip, such that each inlet pair has the same pressure drop.

After passing through the electrochemical cell conduits in the chips, the liquids are directed away from the chips through microfluidic outlet pairs, which are combined into outlet channels 1650 and 1652. The outlet channels direct the liquids to the recycler 1630. The recycler separates the carrier liquid, reaction products and/or residual reactants from the liquid streams. The recycler may include optional evaporator 1632 to selectively separate gas phase components from the liquids. Gas phase from the evaporator is processed by optional gas chromatograph 1634, to isolate components such as water, carbon dioxide, and residual reactants. The recycler may include optional liquid chromatography system 1636, which includes one or more liquid chromatographs for separation of the components of the liquid. The waste components of the outlet liquids are either vented or directed to a waste receptacle. Any reactants that have crossed over, for example reductant in the oxidant liquid or oxidant in the reductant liquid, are separated and recombined with the appropriate liquid. There may be a stabilization period at startup when contamination in the liquids will increase before the purification process begins to be effective. The carrier liquids and residual reactants are directed back to the reservoir 1610. The reservoir may serve as a heat exchanger for the liquids, dissipating excess heat from the liquids prior to recirculating the liquid through the system.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. An electronic device, comprising:
an integrated circuit comprising a plurality of domains, and
at least one bias source,
where each domain of the plurality of domains is independently electrically connected to at least one of the at least one bias source.

2. The electronic device of claim 1, where the at least one bias source is a plurality of bias sources.

3. The electrical device of claim 1, where the at least one bias source comprises at least one fuel cell.

4. The electrical device of claim 2, where the plurality of bias sources comprises a plurality of fuel cells.

5. The electronic device of claim 1, where the at least one bias source comprises at least one battery.

6. The electronic device of claim 1, where each domain of the plurality of domains is independently electrically connected to one bias source of the at least one bias source.

7. The electronic device of claim 2, where each domain of the plurality of domains is independently electrically connected to one bias source of the plurality of bias sources, and each bias source of the plurality of bias sources is electrically connected to one domain of the plurality of domains.

8. The electronic device of claim 6, where the at least one bias source comprises at least one fuel cell.

9. The electrical device of claim 7, where the plurality of bias sources comprises a plurality of fuel cells.

10. The electrical device of claim 8, where the integrated circuit is on a semiconductor substrate, and the at least one bias source is on the semiconductor substrate.

11. The electrical device of claim 9, where the plurality of bias sources are on a semiconductor substrate.

12. The electrical device of claim 11, where the integrated circuit is on the semiconductor substrate.

13. The electrical device of claim 12, where
the semiconductor substrate comprises a first surface,
the semiconductor substrate comprises a second surface opposite the first surface,
the plurality of domains are on the first surface, and
the plurality of bias sources are on the second surface.

14. The electrical device of claim 10, where
the semiconductor substrate comprises a first surface,
the semiconductor substrate comprises a second surface opposite the first surface,
the plurality of domains are on the first surface, and
the at least one bias source is on the second surface.

15. An integrated circuit, comprising:
a semiconductor substrate,
at least one domain on the semiconductor substrate, and
at least one fuel cell on the semiconductor substrate;
where each domain of the at least one domain is independently electrically connected to a fuel cell of the at least one fuel cell.

16. The integrated circuit of claim 15, where the at least one fuel cell is a plurality of fuel cells, and the at least one domain is a plurality of domains.

17. The integrated circuit of claim 16, where each domain of the plurality of domains is independently electrically connected to one fuel cell of the plurality of fuel cells, and each fuel cell of the plurality of fuel cells is electrically connected to one domain of the plurality of domains.

18. The integrated circuit of claim 16, where the plurality of fuel cells are on the semiconductor substrate.

19. (canceled)

20. A gated electrochemical cell, comprising:
(a) an anode,
(b) a cathode,
(c) a first conduit contiguous with the anode,
(d) a second conduit contiguous with the cathode, and
(e) a membrane gate comprising a gate electrode, between the first conduit and the second conduit.

21-32. (canceled)

33. An electronic device, comprising:
(A) an integrated circuit, and
(B) a plurality of gated electrochemical cells, electrically connected to the integrated circuit.

34-52. (canceled)
